(19) United States
(12) Patent Application Publication
(10) Pub. No.: US 2009/0116797 A1
(43) Pub. Date: May 7, 2009

(54) Optical cable and method for production of an optical cable

(76) Inventors: Andreas Stingl, Bayreuth (DE); Stefan Fruhnert, Ebersdorf (DE)

Correspondence Address: CORNING INCORPORATED, INTELLECTUAL PROPERTY DEPARTMENT, SP-TI-3-1, CORNING, NY, 14831, US

(21) Appl. No.: 12/220,716

(22) Filed: Jul. 28, 2008

Related U.S. Application Data
(63) Continuation of application No. PCT/EP2007/000691, filed on Jan. 26, 2007.

(30) Foreign Application Priority Data
Jan. 27, 2006 (DE) DE102006004011.2

(51) Int. Cl. G02B 6/44

(52) U.S. Cl. 385/103; 385/102

(57) ABSTRACT

An optical cable comprises a cable core (100) containing optical transmission elements (10) surrounding a centrally arranged strain relief element (20). Yarns (31) are arranged as a further strain relief element in a manner surrounding the cable core (100). The entire arrangement is surrounded by a cable sheath (400). A thermoplastic material into which vegetable fibers are embedded as a filler is used as materials for the conductor sleeves (2) of the optical transmission elements, the strain relief elements (20) and the cable sheath (400). The use of such vegetable-fiber-filled plastic materials makes it possible to improve the material properties of conductor sleeve, cable sheath and strain relief elements such as, for example, the shrinkage behavior of materials during production and also the transverse compressive and tensile strength.

### RELATED APPLICATIONS

This application is a continuation of International Application No. PCT/EP2007/000691, filed Jan. 26, 2007, which claims priority to German Application No. DE 102006004011.2, filed Jan. 27, 2006, both applications being incorporated herein by reference.

### TECHNICAL FIELD

The application relates to an optical cable in which at least one component of the optical cable contains a material composed of a plastic. The application furthermore relates to a method for production of an optical cable in which at least one component of the optical cable contains a material composed of a plastic.

### BACKGROUND

An optical cable generally comprises a cable core surrounded by a cable sheath. The cable core can contain a plurality of optical transmission elements embodied for example as tight-buffered conductors or bundle conductors. In the case of a tight-buffered conductor, an optical waveguide is surrounded by a sturdy protective sleeve composed of a suitable plastic material. In the case of a bundle conductor, a plurality of optical waveguides are arranged to form a loose bundle that is surrounded by a conductor sleeve.

In cable production, thermoplastics are predominantly used as materials for the cable sheath and the conductor sleeves of the optical transmission elements. The thermoplastics are heated and extruded with the aid of an extruder as a tube for forming the cable sheath around the cable core, and for forming a conductor sleeve around the optical waveguides arranged to form a bundle. The optical cable is subsequently cooled to room temperature in a cooling basin.

On account of the high coefficient of thermal expansion of plastics, a pronounced material shrinkage occurs in this case. This is caused for example by an orientation shrinkage and a shrinkage process as a result of post-crystallization. The orientation shrinkage is brought about owing to the fact that oriented polymer chains, in the event of a temperature change, endeavor to return to their non-oriented initial state again. A shrinkage process on account of post-crystallization occurs in the case of partly crystalline plastics such as, for example, polyamide or polybutylene terephthalate. The crystallites have melted after heating of the polymer. The polymer material partly crystallizes during a subsequent cooling process. The crystallization process continues even after cooling in the form of a post-crystallization, whereby material shrinkage is brought about.

High axial compressing forces occur as a result of such thermal shrinkage owing to cooling of the optical cable after sheath extrusion. In order to prevent the excess fiber length from not exceeding a specified length on account of cable shrinkage, a shrinkage process of a conductor or of the cable sheath always has to be monitored and compensated for in cable production. In order to compensate for the shrinkage, supporting elements composed of a glass-fiber-reinforced plastic or a steel are often used at the present time.

In the case of unsupported cable structures, a sheath shrinkage is transmitted directly to the cable core. In the case of such cable structures, attempts are made to compensate for the conductor or sheath shrinkage by targeted production-technological intervention in line parameters within a production line. For this purpose, by way of example, the fibers, conductors or the entire cable core are or is prestressed or prestretched.

During operation of the optical cable, too, the thermoplastic materials exhibit a pronounced thermal shrinkage or expansion behavior in the event of temperature changes, and this behavior can adversely affect the cable properties such as, for example, the optical attenuation. The shrinkage or expansion of the sheath material therefore has to be compensated for production-technologically and structurally. In order to compensate for shrinkage and expansion during operation of the optical cable, supporting elements composed of glass-fiber reinforced plastic or metallic reinforcement means are likewise provided predominantly within the cable core.

One specific requirement made of an optical cable is the transverse compressive strength and the tensile strength of the conductor or cable. It is substantially characterized by the cable construction and the material parameters such as the modulus of elasticity (E modulus), the creep modulus, the yield stress, the breaking stress and the impact strength. A high E modulus, a high breaking stress or elongation at break, a high impact strength and a small decrease in the creep modulus as a function of time/loading are desirable. In order to achieve the required transverse compressive strength, the cable construction is currently adapted according to requirements with regard to cable type and conductor and cable dimensions. In order to achieve the required tensile strength, tension elements composed of aramid, glass-fiber-reinforced plastics or metals are embedded into the optical cable.

Thermoplastic materials generally exhibit under constant loading a time-dependent deformation or “creep.” The thermoplastics used in the conductor sheath or cable sheath exhibit a pronounced creep behavior. In order to increase the creep strength in optical cables under load, at the present time for example the cable dimensioning is increased or creep-resistive materials such as glass-fiber reinforced plastics, aramid or steel are used within the optical cable.

The thermoplastic materials used in cable production primarily contain synthetically polymerized hydrocarbons. From environmental technological standpoints such as energy consumption and conservation of resources, it is desirable to reduce the proportion of synthetically polymerized plastics or to replace thermoplastics based on synthetically polymerized hydrocarbons by more environmentally friendly materials. Protection of the environment is currently taken into account only in the context of recycling methods that enable the synthetic plastics to be reused.

### SUMMARY

An optical cable according to the present invention and a method of production therefor provides improved optical transmission properties.

The optical cable has a cable core comprising at least one optical transmission element with at least one optical waveguide, and comprising a sleeve surrounding the cable core. The sleeve is formed from a plastic material containing a filler, wherein the filler contains natural fibers.

In one embodiment of the optical cable, the natural fibers are embodied as vegetable fibers. The vegetable fibers can be embodied for example as wood fibers. In further embodiments, the vegetable fibers can also be embodied as bamboo, coconut, hemp, jute, sisal or flax fibers.

In accordance with one development of the optical cable, the vegetable fibers are embedded with a length of up 50 mm into the plastic material. The vegetable fibers can also be ground and embedded in the form of a fiber meal into the plastic material.

In another embodiment is provided that, in the optical cable, the proportion by mass of the vegetable fibers in the total mass of the sleeve is more than 5%, in particular between 30% and 60%. Another embodiment provides for the proportion of mass of the vegetable fibers in the total mass of the sleeve to be up to 95%.

In a further configuration of the optical cable, the plastic material contains a polymer. The sleeve of the optical cable can contain a vegetable-fiber reinforced plastic.

In another embodiment of the optical cable, the sleeve is formed from at least two layers. One of the at least two layers of the sleeve comprises a plastic material containing a filler, wherein the filler contains vegetable fibers.

The sleeve of the optical cable can be embodied as a cable sheath of the optical cable.

In accordance with a further embodiment of the optical cable, the at least one optical transmission element has a sleeve surrounding the at least one optical waveguide. The sleeve of the at least one optical transmission element comprises a plastic material containing a filler, wherein the filler contains vegetable fibers.

In accordance with another embodiment of the optical cable, the at least one optical transmission element comprises a plurality of optical waveguides arranged to form an optical waveguide bundle.

In accordance with one preferred embodiment, the cable core has at least one strain relief element. The at least one strain relief element comprises a plastic material which can be made from the same plastic material as the sleeve of the optical cable, wherein the plastic material contains a filler, wherein the filler contains vegetable fibers.

In accordance with a further feature of the optical cable, the optical cable comprises a plurality of the optical waveguide bundles. The at least one strain relief element is arranged centrally in the cable core, wherein the plurality of the optical waveguide bundles are arranged around the at least one strain relief element.

A further embodiment provides for the at least one strain relief element to be formed from at least two layers. One of the at least two layers comprises a glass-fiber-reinforced plastic material and another of the at least two layers comprises a plastic material containing a filler, wherein the filler contains vegetable fibers.

Another embodiment of the optical cable provides for the at least one optical transmission element to contain a plurality of optical waveguides arranged to form an optical waveguide bundle. The cable core has at least one strain relief element arranged centrally in the cable core. The optical cable comprises a plurality of optical transmission elements arranged around the at least one strain relief element. A dummy conductor is arranged around the at least one strain relief element, the dummy conductor comprising a sleeve surrounding a vegetable-fiber-reinforced plastic material.

In accordance with a further embodiment of the optical cable, the at least one strain relief element contains a plurality of yarns surrounding the plurality of the optical waveguide bundles.

In one possible form of the optical cable, the at least one optical transmission element is embodied as a fiber ribbon comprising a plurality of the at least one optical waveguide. The optical transmission element is surrounded by a plurality of the at least one strain relief element.

A method for production of an optical cable is specified below. The method provides for providing a plastic material containing a polymer and a filler material, wherein the filler material contains natural fibers. The plastic material is heated. A cable core is furthermore provided, comprising at least one optical transmission element with at least one optical waveguide. The heated plastic material is extruded around the cable core in order to form a cable sheath.

The plastic material may be a vegetable-fiber-reinforced plastic material with the filler material containing vegetable fibers.

In accordance with another embodiment of the method, a plurality of the at least one optical waveguide are arranged to form an optical waveguide bundle. The heated vegetable-fiber-reinforced plastic material is extruded around the optical waveguide bundle in order to form a sleeve of the optical waveguide bundle.

Another embodiment of the method comprises providing a strain relief element containing a vegetable-fiber-reinforced plastic material. A plurality of the optical waveguide bundle are furthermore provided. The plurality of the optical waveguide bundle are arranged around a periphery of the strain relief element.

In one embodiment of the method, yarns are arranged as strain relief elements around the cable core. The yarns contain a vegetable-fiber-reinforced plastic material.

The invention is explained in more detail below with reference to figures showing exemplary embodiments of the present invention.

### BRIEF DESCRIPTION OF THE FIGURES

FIG. 1 shows a first embodiment of an optical cable which contains a thermoplastic material into which is embedded a material composed of vegetable fibers as filler.

FIG. 2 shows a second embodiment of an optical cable which contains a thermoplastic material into which is embedded a material composed of vegetable fibers as filler.

FIG. 3 shows a third embodiment of an optical cable which contains a thermoplastic material into which is embedded a material composed of vegetable fibers as filler.

FIG. 4 shows a cable core of an optical cable, which cable core contains a thermoplastic material into which is embedded a material composed of vegetable fibers as filler.

FIG. 5 shows a fourth embodiment of an optical cable which contains a thermoplastic material into which is embedded a material composed of vegetable fibers as filler.

FIG. 6 shows a manufacturing unit for production of an optical cable with a reduced proportion of thermoplastic materials.

### DETAILED DESCRIPTION

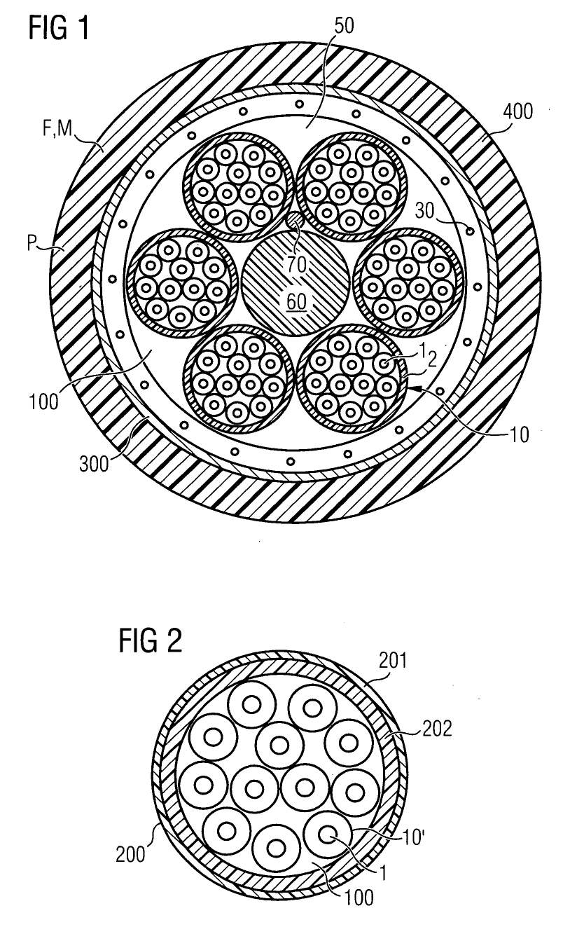

FIG. 1 shows a first embodiment of an optical cable which comprises a cable core 100 surrounded by a cable sheath 400. The cable core 100 contains a centrally arranged supporting element 60 composed of a glass-fiber-reinforced plastic. A plurality of optical transmission elements 10 in the form of bundle conductors are arranged circumferentially around the supporting element 60. A bundle conductor of this type comprises a plurality of optical waveguides 1 surrounded by a conductor sleeve 2. The optical cable can be embodied as a cable free of filler composition or as a cable having a core filler composition 50, as shown in FIG. 1. The core filler composition prevents moisture from being able to propagate within the cable core in a longitudinal direction along the optical transmission elements. In order to support this effect, the cable core contains a swellable yarn 70 containing an SAP (Super Absorbent Polymer) powder, for example.

The cable core 100 is surrounded by a nonwoven sleeve 300, over which the cable sheath 400 is extruded. The nonwoven sleeve 300 forms a thermal protection of the cable core against the high temperatures that occur during the extrusion of the cable sheath 400. The nonwoven sleeve 300 can additionally have the function of preventing the penetration of moisture into the cable core. For this purpose, in the same way as the swellable yarn, the nonwoven sleeve contains an SAP powder. Salts composed of an acrylic acid are used, for example, as SAP materials. Upon contact with moisture, the SAP powder brings about an increase in the volume of the nonwoven sleeve 300 and of the swellable yarn 70, respectively, such that the nonwoven sleeve and the swellable yarn swell and seal the cable core against penetrating water. According to the invention, the cable sheath 400 contains a thermoplastic material into which is embedded a material composed of a vegetable (e.g., plant) fiber as filler. The conductor sleeve 10 can likewise also comprise a thermoplastic material containing a material composed of a vegetable fiber as filler.

FIG. 2 shows a further embodiment of an optical cable, in which the proportion of thermoplastic materials is reduced. The optical cable in FIG. 2 comprises a cable core 100 containing a plurality of tight-buffered conductors 10′ as optical transmission elements. A tight-buffered conductor 10′ has in its interior an optical waveguide 1 surrounded by a steady protective sleeve composed of a plastic material. The cable core 100 is surrounded by a multilayered construction, in the case of the cable arrangement in FIG. 2 by a two-layered construction of a sleeve 200. The sleeve 200 comprises a layer 201 containing a thermoplastic material and a layer 202 containing a thermoplastic material into which is embedded a material composed of a vegetable fiber as filler.

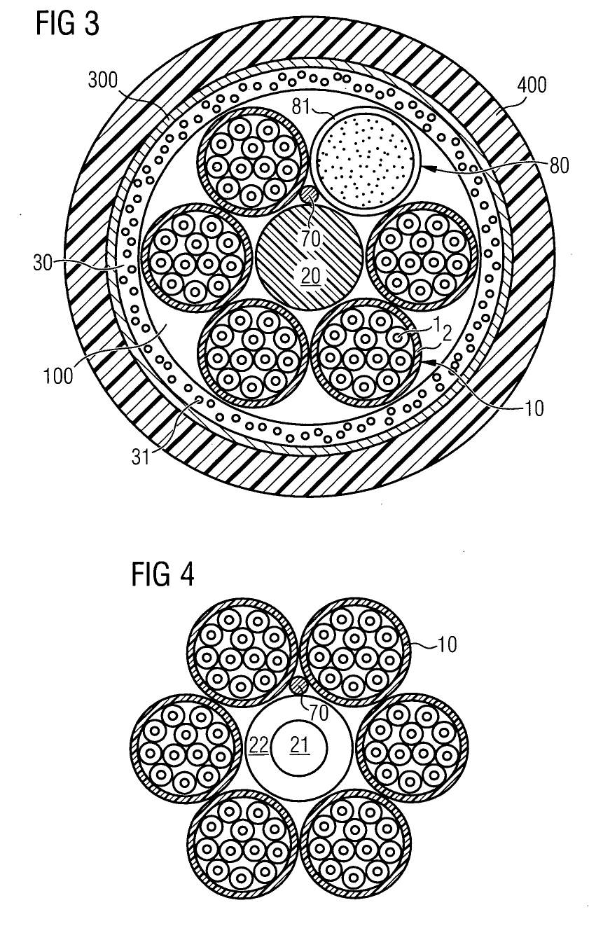

FIG. 3 shows a further embodiment of an optical cable, in which the proportion of thermoplastic materials is reduced. The optical cable is similar to the cable arrangement illustrated in FIG. 1. It comprises a cable core 100 containing a plurality of bundle conductors 10 arranged around a centrally arranged strain relief element 20. A swellable yarn 70 is provided for sealing the cable core. The strain relief element 20 comprises a thermoplastic material containing a material composed of a vegetable fiber as filler. The cable core 100 is surrounded by a further strain relief element 30. The strain relief element 30 contains a plurality of yarns 31 comprising a plastic material containing a material composed of a vegetable fiber as filler. The strain relief element 30 is surrounded by a nonwoven sleeve 300 in a manner similar to the cable arrangement in FIG. 1, a cable sheath 400 being extruded around the sleeve.

Besides the use of organic fiber structures as filler for the thermoplastic materials of the yarns 31 and of the centrally arranged strain relief element 20, the conductor sleeves of the bundle conductors and also the cable sheath 400 can also comprise a plastic material containing a material composed of a vegetable fiber as filler.

Furthermore, the strain relief element 20 can also be surrounded by at least one dummy conductor 80 alongside the optical transmission elements. Such dummy conductors have hitherto comprised a material composed of a pure plastic over which a conductor sleeve is extruded. It is proposed to use, as material for the dummy conductor, a thermoplastic material into which is embedded an organic filler composed of a material composed of a vegetable fiber. The vegetable-fiber-reinforced material is surrounded by a sleeve 81.

FIG. 4 shows a cable core of an optical cable. A plurality of bundle conductors 10 and a swellable thread 70 are arranged around a centrally arranged strain relief area. The strain relief element has an inner layer 21 and an outer layer 22. The inner layer 21 is formed from a plastic material. The outer layer 22 comprises a plastic material into which is embedded a material composed of a vegetable fiber as filler.

FIG. 5 shows an optical cable embodied as a ribbon cable. The optical transmission element 10 comprises a plurality of optical waveguides 1 arranged alongside one another. Strain relief elements 40 are situated within the cable core 100, which is surrounded by a cable sheath 400. The strain relief elements comprise a plastic material in which is embedded a material composed of vegetable fiber as filler.

As shown in FIGS. 1 to 5, the conductor sleeves 2, the sleeve 200 surrounding the cable core, the cable sheath 400 and also the strain relief elements contain a thermoplastic material into which is embedded a material composed of a vegetable fiber as filler. Polymers, for example polyethylene, polypropylene, polystyrene, polyamide, polybutylene terephthalate and/or epoxy resins and also polyester resins are used as thermoplastic materials. Vegetable fibers composed of soft/hard wood, hemp, sisal, jute, coconut wood, bamboo or flax are used as organic filler materials.

The stability of such vegetable-fiber-reinforced plastics can be crucially influenced by the fiber proportion and the type of fibers. The higher the proportion of vegetable fibers, the more stable and less sensitive the material with respect to a shrinkage process and with regard to the tensile and transverse compressive strength. These vegetable fiber materials are embedded into the thermoplastic base materials as fillers, which may be in a proportion by volume of 5% to 95%.

The fibers used are long fibers having lengths of up to 5 mm or short fibers having lengths of between 0.1 mm and 0.5 mm. However, a fiber meal can also be used instead of the fibers. For this purpose, the vegetable fibers are found to form fine particles having a grain size of less than 100 μm. The fiber meal thus obtained may accordingly be used for sleeves having thin wall thicknesses. The surface quality of a sleeve containing such a vegetable-fiber-reinforced plastic is improved when fiber meal is used instead of fragments of vegetable fibers.

The material properties of cable sheaths, conductor cores and strain relief elements for optical cables can be crucially improved by the use of materials composed of vegetable fibers as fillers for thermoplastic materials. Thus, the use of vegetable fibers as fillers for thermoplastic materials which are used for conductor sleeves and cable sheaths brings about a supporting effect and hence a reduction of the material shrinkage in the course of cooling from a high extruding temperature to room temperature. The dimensional accuracy of the extrudate is improved by the supporting effect of the vegetable fibers. Thus, by way of example, wood fibers composed of solid wood have a coefficient of thermal expansion that is approximately a factor of 10 smaller than that of unfilled thermoplastic materials.

Owing to the reduced shrinkage, strain relief elements composed of glass-fiber reinforced plastics or steel which had hitherto prevented or curbed the sheath shrinkage can either be completely omitted or constructed with significantly less material. Thus, it is possible, for example, to provide the strain relief element 20 having a significantly smaller diameter as a central supporting element in the cable core. It is also possible, as shown in FIG. 4, to provide a two-layered construction for the strain relief element 20. In this case, the inner layer 21 comprises for example a glass-fiber-reinforced plastic or a steel element on which a layer composed of a vegetable-fiber-reinforced plastic 22 is applied. This results in a saving of plastic material and thus also in a saving of costs since the costs of natural-fiber-reinforced plastics are less than the costs of pure plastic material.

The coefficient of thermal expansion of the plastic materials is significantly reduced by the use of vegetable fibers as fillers for thermoplastic materials. It has been shown that it is possible to halve the coefficient of linear thermal expansion when using vegetable-fiber-reinforced plastics in comparison with the use of pure thermoplastics.

Furthermore, the transverse compressive strengthening and the tensile strength of conductor sleeves or of the entire optical cable are increased. In the case of a filling of the thermoplastic material with 30% hemp fibers, the E modulus of polypropylene is increased for example by a factor of 3 to 4. In addition, the yield point and the impact strength are also increased. Owing to the improvement of transverse compressive and tensile strength, material can be saved when using additional traditional tension elements composed of aramid or glass-fiber-reinforced plastics. Furthermore, vegetable-fiber-reinforced plastics exhibit a very favorable creep behavior on account of the elastic structure of the vegetable fibers.

Furthermore, when plastic materials containing vegetable fibers as filler are used, oil resources are conserved with regard to environmental protection. Consequently, filling polymer materials with up to 95% organic filler can make a valuable contribution to environmental protection. Furthermore, when processing thermoplastic materials having high proportions of fillers composed of vegetable fibers, operational and manufacturing installations are exposed to milder conditions since organic fillers, in contrast to inorganic fillers, bring about less machine and tool wear.

Furthermore, the costs for vegetable-fiber-reinforced plastics are significantly lower than the costs of pure thermoplastic materials or of thermoplastic materials into which inorganic fillers are embedded. Besides the reduction of costs, the use of vegetable-fiber-filled plastic materials is also associated with a reduction in the weight of the optical cable.

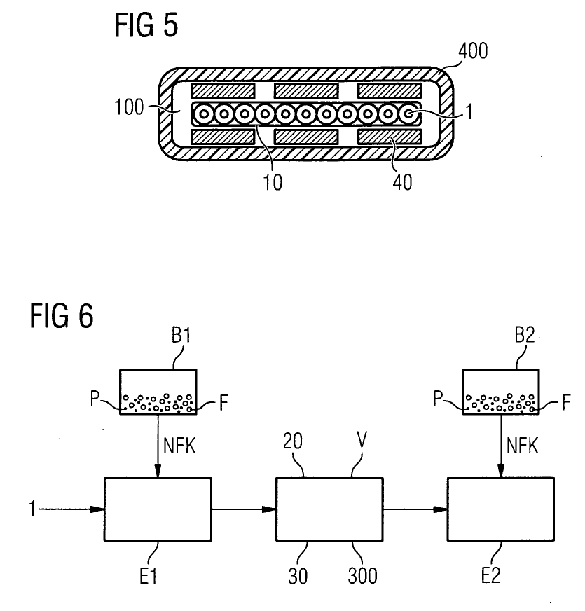

FIG. 6 shows a production line for production of an optical cable in a simplified illustration. A container B1 contains a thermoplastic material P into which is embedded a material composed of vegetable fibers F as filler. The container B1 is connected to an extruder E1. A bundle of optical waveguides 1 is fed to the extruder E1. In the container B1, the matrix material composed of the thermoplastic and the filler material composed of the vegetable fibers are heated and likewise fed to the extruder E1. In the extruder E1, the vegetable-fiber-reinforced plastic material NFK is extruded as a conductor sleeve 2 around the optical waveguides 1 arranged to form a bundle.

A plurality of these bundle conductors are fed to a processing unit V. The cable core of the optical cable is formed in the processing unit V. For this purpose, a strain relief element 20 containing a vegetable-fiber-reinforced plastic material is fed to the processing unit V. Furthermore, yarns 30 that likewise contain a vegetable-fiber-reinforced plastic are fed to the processing unit V. In the processing unit V, the bundle conductors are arranged around the central strain relief element 20 formed from the vegetable-fiber-reinforced plastic material. The yarns 30 are arranged around the cable core thus formed and hold together the loose arrangement of the bundle conductors around the centrally arranged strain relief element.

The cable core thus formed is subsequently fed to an extruder E2. A container B2 is connected to the extruder E2. The container contains a plastic material P into which is embedded an organic filler material composed of vegetable fibers F. This material mixture is heated in the container B2 and fed as vegetable-fiber-reinforced plastic material NFK to the extruder E2. In the extruder E2, the vegetable-fiber-reinforced plastic material NFK is extruded as a cable sheath 400 around the nonwoven sleeve 300.

The mixtures of a thermoplastic material and the vegetable fibers can be produced in various processing methods such as the injection molding, the extrusion, casting and laminating method and also compression molding, continuous or profile casting. Consequently, it is also possible to produce very small filigree forms containing a thermoplastic material with embedded vegetable fibers.

Vegetable fibers such as coconut fibers, for example, are obtained in a machine similar to a hammer mill, the decorticator. The fiber husks are slightly moistened prior to their processing and are then fed to the decorticator. In the decorticator, the fiber husks are broken open by a shaft occupied by beater arms. This gives rise to approximately 65% dust and a fiber mixture, which is subsequently dried. Other vegetable fibers such as jute fibers, for example, are obtained by mechanically combing out the fiber husks.

A twin-screw extruder, for example, can be used for introducing the vegetable fibers into a plastic material, so-called compounding. The screw configuration and the location of the fiber intake are optimized with regard to the least possible fiber damage during the compounding process. Situated upstream of a fiber intake is a kneading element that ensures that a homogeneous melt of the thermoplastic material is already present at the fiber intake. The fiber incorporating section merely consists of a long conveying section without kneading elements. In this way, the fibers can be incorporated homogeneously into the plastic melt.

### LIST OF REFERENCE SYMBOLS

1 Optical waveguide
2 Conductor sleeve
10 Optical transmission element
11 Dummy conductor
20 Central strain relief element
30 Strain relief element
31 Yarn
40 Strain relief element
50 Core filler composition
60 Strain relief element
70 Swellable yarn
80 Aramid yarn
100 Cable core
200 Sleeving
300 Nonwoven sleeve
400 Cable sheath
B Container
E Extruder
F Vegetable fiber
NFK Vegetable-fiber-reinforced plastic material
P Polymer
V Processing unit

1. An optical cable comprising:
a cable core comprising at least one optical transmission element with at least one optical waveguide; and
a sleeve surrounding the cable core,
wherein the sleeve is formed from a plastic material containing a filler, wherein the filler contains natural fibers.

2. The optical cable of claim 1, wherein the natural fibers comprise vegetable fibers.

3. The optical cable of claim 2, wherein the vegetable fibers comprise wood fibers.

4. The optical cable of claim 2, wherein the vegetable fibers comprise bamboo fibers.

5. The optical cable of claim 2, wherein the vegetable fibers comprise coconut fibers.

6. The optical cable of claim 2, wherein the vegetable fibers comprise hemp fibers.

7. The optical cable of claim 2, wherein the vegetable fibers comprise sisal fibers.

8. The optical cable of claim 2, wherein the vegetable fibers comprise jute fibers.

9. The optical cable of claim 2, wherein the vegetable fibers comprise flax fibers.

10. The optical cable of claim 2, wherein the vegetable fibers are embedded with a length of up to 50 mm into the plastic material.

11. The optical cable of claim 2, wherein the vegetable fibers are embedded in the form of a fiber meal into the plastic material.

12. The optical cable of claim 2, wherein the proportion by mass of the vegetable fibers in the total mass of the sleeve is more than 5%.

13. The optical cable of claim 2, wherein the proportion by mass of the vegetable fibers in the total mass of the sleeve is up to 95%.

14. The optical cable of claim 1, wherein the plastic material contains a polymer.

15. The optical cable of claim 1, wherein the sleeve contains a vegetable-fiber-reinforced plastic.

16. The optical cable of claim 1,
wherein the sleeve is formed from at least two layers,
wherein one of the at least two layers of the sleeve comprises a plastic material containing a filler, and
wherein the filler contains vegetable fibers.

17. The optical cable of claim 1, wherein the sleeve comprises a cable sheath of the optical cable.

18. The optical cable of claim 1, wherein the at least one optical transmission element has a sleeve surrounding the at least one optical waveguide; and
wherein the sleeve of the at least one optical transmission element comprises a plastic material containing a filler, wherein the filler contains vegetable fibers.

19. The optical cable of claim 18, wherein the at least one optical transmission element comprises a plurality of optical waveguides arranged to form an optical waveguide bundle.

20. The optical cable of claim 1,
wherein the cable core has at least one strain relief element,
wherein the at least one strain relief element comprises a plastic material of the same plastic material as the sleeve of the optical cable, and
wherein the plastic material contains a filler, wherein the filler contains vegetable fibers.

21. The optical cable of claim 20,
wherein the optical cable comprises a plurality of the optical waveguide bundles,
wherein the at least one strain relief element is arranged centrally in the cable core, and
wherein the plurality of the optical waveguide bundles are arranged around the at least one strain relief element.

22. The optical cable of claim 20,
wherein the at least one strain relief element is formed from at least two layers,
wherein one of the at least two layers comprises a glass-fiber-reinforced plastic material and another of the at least two layers comprises a plastic material containing a filler, and
wherein the filler contains vegetable fibers.

23. The optical cable of claim 1,
wherein the at least one optical transmission element contains a plurality of optical waveguides arranged to form an optical waveguide bundle,
wherein the cable core has at least one strain relief element arranged centrally in the cable core,
wherein the optical cable comprises a plurality of optical transmission elements arranged around the at least one strain relief element, and
wherein a dummy conductor is arranged around the at least one strain relief element, the dummy conductor comprising a sleeve surrounding a vegetable-fiber-reinforced plastic material.

24. The optical cable of claim 20, wherein the at least one strain relief element contains a plurality of yarns surrounding the plurality of the optical waveguide bundles.

25. The optical cable of claim 20,
wherein the at least one optical transmission element comprises a fiber ribbon comprising a plurality of the at least one optical waveguide, and
wherein the optical transmission element is surrounded by a plurality of the at least one strain relief element.

26. A method for production of an optical cable, comprising:
providing a plastic material containing a polymer and a filler material, wherein the filler material contains natural fibers;
heating the plastic material;
providing a cable core comprising at least one optical transmission element with at least one optical waveguide; and
extruding the heated plastic material around the cable core in order to form a cable sheath.

27. The method of claim 26, wherein the plastic material comprises a vegetable-fiber-reinforced plastic material, and wherein the filler material contains vegetable fibers.

28. The method of claim 27, further comprising:
arranging a plurality of the at least one optical waveguide to form an optical waveguide bundle; and
extruding the heated vegetable-fiber-reinforced plastic material around the optical waveguide bundle in order to form a sleeve of the optical waveguide bundle.

29. The method of claim 28, further comprising:
providing a strain relief element containing a vegetable-fiber-reinforced plastic material;
providing a plurality of the optical waveguide bundles; and
arranging the plurality of the optical waveguide bundle around a periphery of the strain relief element.

30. The method of claim 27,
wherein yarns are arranged as strain relief elements around the cable core, and
wherein the yarns contain a vegetable-fiber-reinforced plastic material.
